(19) United States
(12) Patent Application Publication
(10) Pub. No.: US 2010/0077628 A1
(43) Pub. Date: Apr. 1, 2010

(54) Clothes dryer having fragrance supplying apparatus using vibrator

(76) Inventors: Sang Hun Bae, Changwon (KR); Min Ji Kim, Changwon (KR); Tae-Hee Lee, Changwon (KR)

Correspondence Address: MCKENNA LONG & ALDRIDGE LLP, 1900 K STREET, NW, WASHINGTON, DC, 20006, US

(21) Appl. No.: 12/585,787

(22) Filed: Sep. 24, 2009

Related U.S. Application Data
(60) Provisional application No. 61/100,590, filed on Sep. 26, 2008.

(30) Foreign Application Priority Data
Sep. 26, 2008 (KR) 10-2008-0094956

(51) Int. Cl. F26B 19/00; D06F 58/04

(52) U.S. Cl. 34/60; 34/130

(57) ABSTRACT

The present disclosure generally relates to a clothes dryer that can include a main body; a drum rotatably installed at the main body; a storage chamber for storing liquid fragrance to be supplied into the drum; and a vibrator disposed inside the storage chamber and for atomizing the liquid fragrance, in which the liquid fragrance is atomized by using the vibrator so as to be supplied into the drum. The clothes dryer can also include: a main body; a drum rotatably installed in the main body; a storage chamber for storing liquid fragrance to be supplied into the drum; and an atomizer connected to the storage chamber through a hose, and for atomizing the liquid fragrance using a vibrator.

### RELATED APPLICATION

This application claims benefit of Korean Patent Application No. 10-2008-0094956 and U.S. Provisional Patent Application No. 61/100,590 respectively filed on Sep. 26, 2008, which is hereby incorporated by reference for all purposes as if fully set forth herein.

### BACKGROUND OF THE DISCLOSURE

1. Field of the Disclosure

The present disclosure generally relates to a clothes dryer. In particular, the present disclosure relates to a clothes dryer having a fragrance supplying apparatus using a vibrator so as to spray fragrance into a drum.

2. Discussion of the Related Art

A clothes dryer is a device that absorbs moisture from objects to be dried, for instance, a load of laundry, by blowing hot air into a drum and thereby drying the load.

Generally, the clothes dryer has a drum disposed inside where the drum includes a receiving space for receiving laundry therein, a driving motor for driving the drum, a blowing fan for introducing air into the drum, and a heating means for heating air introduced into the drum.

The heating means may use either electric resistance heat of high temperature generated by using electric resistance or heat of combustion generated by burning gas.

Typically, air discharged from the drum is hot and humid by absorbing moisture from the laundry received in the drum. Clothes dryers may be categorized into two types, a condensation type clothes dryer or an exhaust type clothes dryer. The category is based on the method employed for handling air at the high temperature and the humidity occurring when absorbing the moisture and drying the load.

The condensation type clothes dryer uses a recirculation method that removes moisture by condensing the moisture from the humid air flowing from the drum in a heat exchanger and then recirculates the moisture-removed dry air back into the drum. Whereas, typically, the exhaust clothes dryer employs a method for exhausting the humid air flowing from the drum to the outside of the dryer.

When the laundry is placed inside of the dryer to be dried after being washed, the moisture from the laundry is removed, however, the dried clothes may smell of washing water or detergent, or the smell of the clothes before being washed may still remain even after the drying. Thus may cause an unpleasant experience to a user. Therefore, in order to remove such smell and to give a pleasant experience to the user, fragrance may be supplied to the inside of the drum. However, if a fragrance is a liquid, a means to easily spray the fragrance to the drum is required. In addition, if the liquid fragrance needs to be replenished, a means to notify the user when the fragrance source needs to be replenished does not exist.

### SUMMARY

In an embodiment a means is provided to effectively spray liquid fragrance into a drum of a dryer in order to remove smell from objects to be dried and deposit the fragrance onto the objects to be dried.

To achieve these objects and other advantages and in accordance with the purpose of the present invention as embodied and broadly described herein, there is provided a clothes dryer, including: a main body; a drum rotatably installed in the main body; a storage chamber for storing liquid fragrance supplied into the drum; and a vibrator disposed inside the storage chamber and for atomizing the liquid fragrance.

In exemplary embodiments, the liquid fragrance stored in the storage chamber may be conveniently atomized by using a vibrator, thus to spray or atomize the liquid fragrance into the drum of the dryer.

In an embodiment, a clothes dryer, in which a tube may be connected to the storage chamber, and fragrance atomized from the storage chamber may be introduced into the inside of the drum through the tube and then sprayed into the inside of the drum through a spray nozzle disposed at an end of the tube is provided. The tube may have a fan for blowing the atomized fragrance, and the spray nozzle may be disposed at a front supporter or a rear supporter of the dryer so as to face an upper portion of the drum.

In some embodiments, a clothes dryer having a first fluid level sensor for sensing an amount of liquid fragrance in the storage chamber is provided. The first fluid level sensor may be configured to sense an amount of liquid fragrance remaining in the storage chamber, more specifically, to sense whether or not the amount of the liquid fragrance remaining in the storage chamber is less than a preset amount.

In an embodiment, a clothes dryer including a control panel for displaying an operational state of the dryer at an upper portion of a front surface of a dryer main body, is provided. The control panel may include a display unit for displaying an indication notifying to a user that the liquid fragrance needs to be replenished if the amount of the liquid fragrance sensed by the first fluid level sensor is less than a preset amount.

In some embodiments, a clothes dryer in which the vibrator stops operating if the amount of the liquid fragrance sensed by the first fluid level sensor is less than the certain amount is provided.

In an embodiment, a clothes dryer, including: a main body; a drum rotatably installed in the main body; a storage chamber for storing liquid fragrance supplied into the drum where the storage chamber includes a first fluid level sensor; and an atomizer connected to the storage chamber through a hose for atomizing the liquid fragrance using a vibrator.

In some embodiments, the atomizer for atomizing the liquid fragrance may be provided separately from the storage chamber so as to atomize the liquid fragrance.

In exemplary embodiments, a clothes dryer having a second fluid level sensor for sensing an amount of liquid fragrance inside the atomizer, is provided.

In an embodiment, a clothes dryer, in which the hose for connecting the storage chamber and the atomizer has a check valve such that the check valve is opened if an atomized amount of liquid fragrance sensed by the second fluid level sensor is less than a certain amount, is provided.

In some embodiments, a clothes dryer in which the atomizer is communicated with the spray nozzle through a duct for guiding the atomized fragrance into the drum, and a fan for blowing atomized fragrance is disposed inside the duct, is provided.

The clothes dryer may facilitate the spraying of the liquid fragrance into the drum of the dryer while performing the drying operation.

It is to be understood that both the foregoing general description and the following detailed description are exemplary and explanatory and should not be construed as limiting the scope of the claims.

### BRIEF DESCRIPTION OF THE DRAWINGS

The accompanying drawings, are included to provide a further understanding of the disclosure, and are incorporated herein and constitute a part of this application. The drawings, together with the description serve to explain the exemplary embodiments of the present disclosure.

In the drawings:

FIG. 1 illustrates perspective view of a clothes dryer according to one exemplary embodiment of the invention;

FIG. 2 illustrates a longitudinal cross-sectional view of an inside of the clothes dryer in FIG. 1;

FIG. 3 illustrates a perspective view of an inside of the clothes dryer having a fragrance supplying apparatus according to an embodiment of the invention;

FIG. 4 illustrates a view of the clothes dryer in FIG. 3 at another angle;

FIG. 5 illustrates a cross-sectional view of an embodiment of a fragrance supply apparatus in FIG. 4; and

FIG. 6 illustrates a cross-sectional view of an embodiment of a fragrance supply apparatus according to an exemplary embodiment of the present invention.

### DETAILED DESCRIPTION OF THE EMBODIMENTS

Reference will now be made in detail of the specific embodiments of the present invention examples of which are illustrated in the accompanying drawings. Wherever possible, the same reference numbers will be used throughout the drawings to refer to same or like parts.

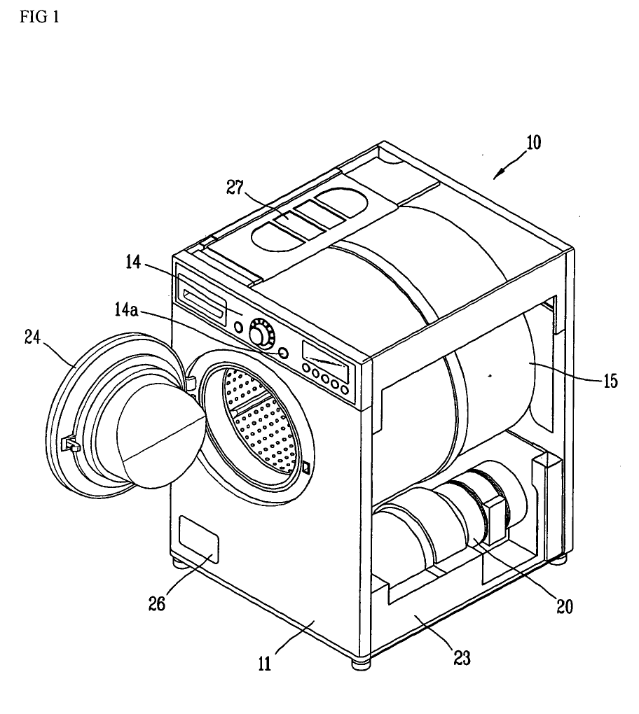

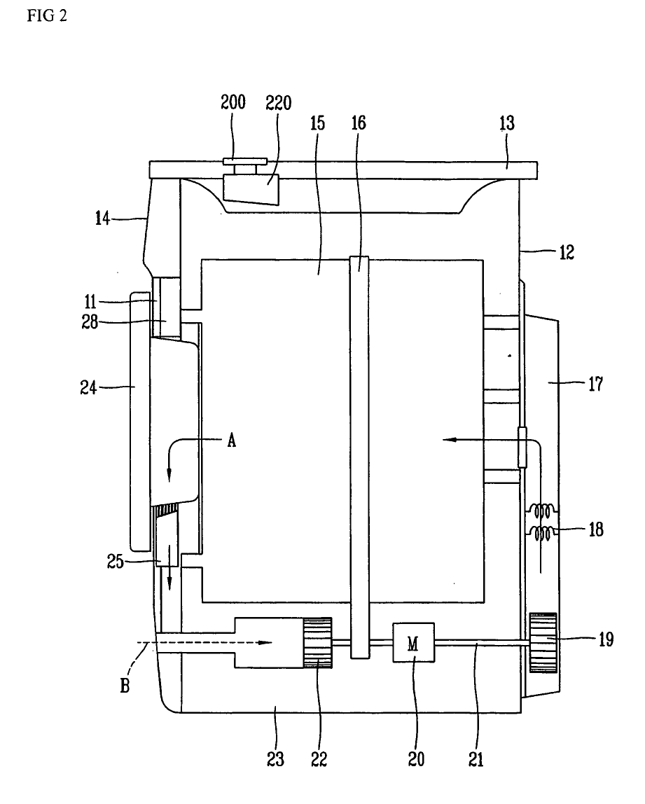

Referring to FIGS. 1 and 2, the clothes dryer 10 can include a front cover 11 forming a front surface of a main body, a rear cover 12 forming a rear surface of the main body, and a top plate 13 forming an upper surface of the main body. The clothes dryer can include a drum 15 disposed inside the dryer main body for receiving objects to be dried.

The clothes dryer 10 can include a front supporter 28 mounted on a rear surface of the front cover 11 and for supporting an entrance opening of the front surface of the drum 15, a door 24 mounted at the front cover 11 so as to open and close the entrance opening of the drum 15, and a control panel 14 disposed at an upper portion of the front cover 11 and having a variety of buttons to receive one or more inputs on drying conditions by a user.

The clothes dryer 10 can include a drying fan 19 for circulating air from the drum 15 in the dryer 10, a drying duct 17 for conducting the flow of the circulated air such that the air flowing from the drum 15 by the drying fan 19 is recirculated back into the drum 15, a heater 18 mounted inside the drying duct 17 for increasing a temperature of air introduced into the drum 15, and a steam generator (not shown) installed at an outer side of the drum 15 for generating steam.

Below the drum 15, a base 23 having a passage channel for circulating air A and a passage of outside air B for heat exchange with the circulation air A, may be provided, a driving motor 20 mounted on the base 23 for driving the drum 15, a belt 16 for transferring a rotation force generated from the driving motor 20 to the drum 15, a cooling fan 22 connected to a motor shaft 21 of the driving motor 20 for sucking indoor air, and a condenser 26 mounted inside the base 23 for heat exchange between the indoor air and the circulation air, may be provided.

In FIG. 2, reference numeral 200 denotes a cover and reference numeral 220 denotes a storage chamber, which may be attached to the top plate and may be part of the fragrance supplying apparatus for supplying fragrance into the drum. Hereinafter, descriptions thereof will be given in more detail.

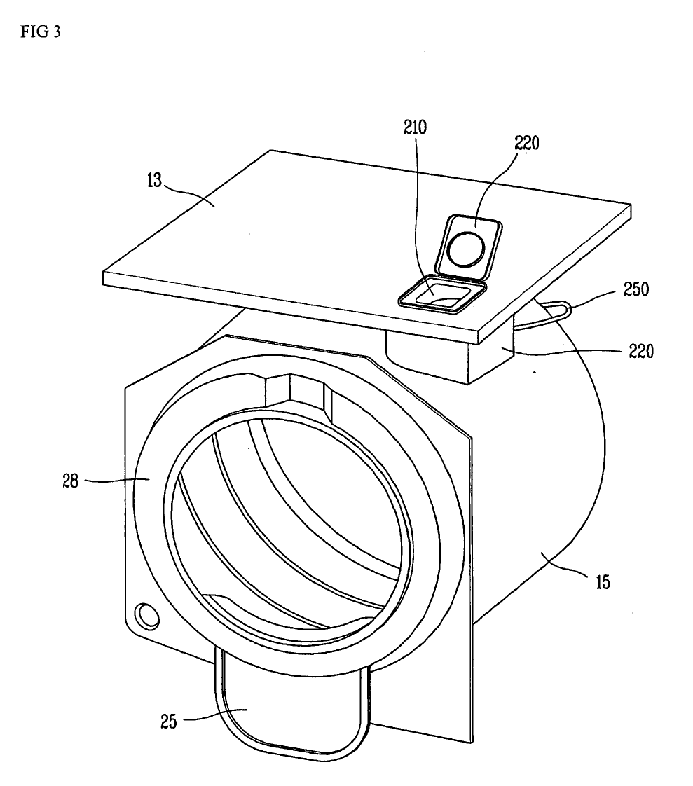

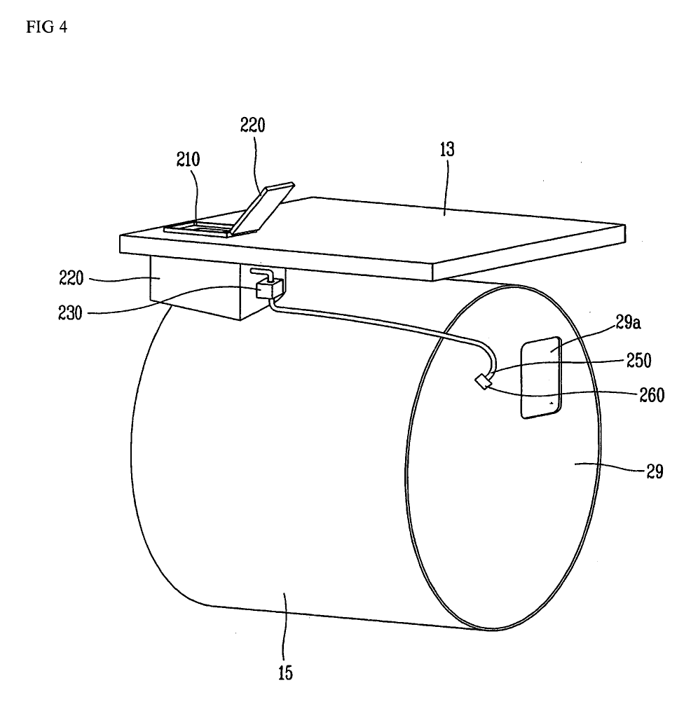

FIG. 3 is a perspective view illustrating an inside of the clothes dryer having a fragrance supplying apparatus according to one exemplary embodiment of the present invention, and FIG. 4 is a view illustrating another angle of the clothes dryer in FIG. 3. For the sake of convenience in explanation, the illustration of the dryer in FIGS. 3 and 4 is simplified to include the top plate 13, the drum 15, the front supporter 28 for supporting the drum at a front and the fragrance supplying apparatus according to an exemplary embodiment of the present invention.

The fragrance supplying apparatus according to an exemplary embodiment of the present invention may be mounted at one side of the top plate 13 for supplying fragrance into the drum. The top plate 13 can have a through hole through which the fragrance supplying apparatus may be mounted.

More specifically, a cover unit 201 may include a cover 200 for opening and closing the storage chamber 220 of the fragrance supplying apparatus, and a cover coupling portion 210 to which the cover may be coupled. The cover coupling portion 210 may be mounted at the top plate 13 through the through hole by using a coupling means such as, for example, a screw or hook. The cover 200 of the cover unit 201 may be coupled to one side of the cover coupling portion 210 by, for example, a hinge, and a means for opening and closing the cover 200 may be provided at another side of the cover coupling portion 210. Accordingly, when liquid fragrance is supplied to the fragrance supplying apparatus, the user can open the cover 200 first and supply the liquid fragrance into the storage chamber. After supplying the liquid fragrance, the cover 200 can be closed so as to prevent evaporation of the liquid fragrance stored in the storage chamber 220 as well as leakage of the liquid fragrance to an outside. Preferably, a sealing member (not shown) for sealing between the cover unit 201 and the storage chamber 220 may be provided to prevent leakage of the fragrance to the outside.

FIG. 5 is a cross-sectional view illustrating the storage chamber 220 of the fragrance supplying apparatus in FIG. 4.

A vibrator receiving recess 221 may be formed on a bottom of the storage chamber 220, and the vibrator 222 can be received by the vibrator receiving recess 221. A first fluid level sensor 223 may be provided at one side of the lower portion of the storage chamber 220 so as to sense an amount of liquid fragrance stored in the storage chamber 220. Here, the first fluid level sensor 223 may be, for example, an electrode sensor or a lead switch sensing an impact between magnets. If an amount of the liquid fragrance sensed by the sensor is determined to be less than a certain preset amount, the user is notified such that the liquid fragrance is replenished. For this, a display unit 14a for displaying the amount of the liquid fragrance may be disposed at the control panel 14 of an upper front surface of the dryer. The liquid fragrance at a certain fixed amount remains at the lower portion of the storage chamber 220 where the vibrator 222 is positioned. When the vibrator 222 vibrates at a high frequency caused by a high frequency oscillator (not shown), the liquid fragrance contacting the vibrator 222 turns into a form of a mist, which is called ‘atomized phenomenon.’

By such atomized phenomenon, the liquid fragrance is atomized to be supplied to an upper side of the storage chamber, which may be connected to one side of the tube 250 so as to discharge and guide the atomized fragrance. The spray nozzle 260 for spraying the fragrance into the drum may be connected to another side of the tube 250. Then, the atomized fragrance may be introduced into the spray nozzle 260 through the tube 250 so as to be supplied into the drum. Tube 250 may include a blowing fan 230 in order to effectively supply the atomized fragrance, and, the spray nozzle 260 may be disposed at the front supporter 28 or the rear supporter 29 of the dryer so as to face the inside of the drum.

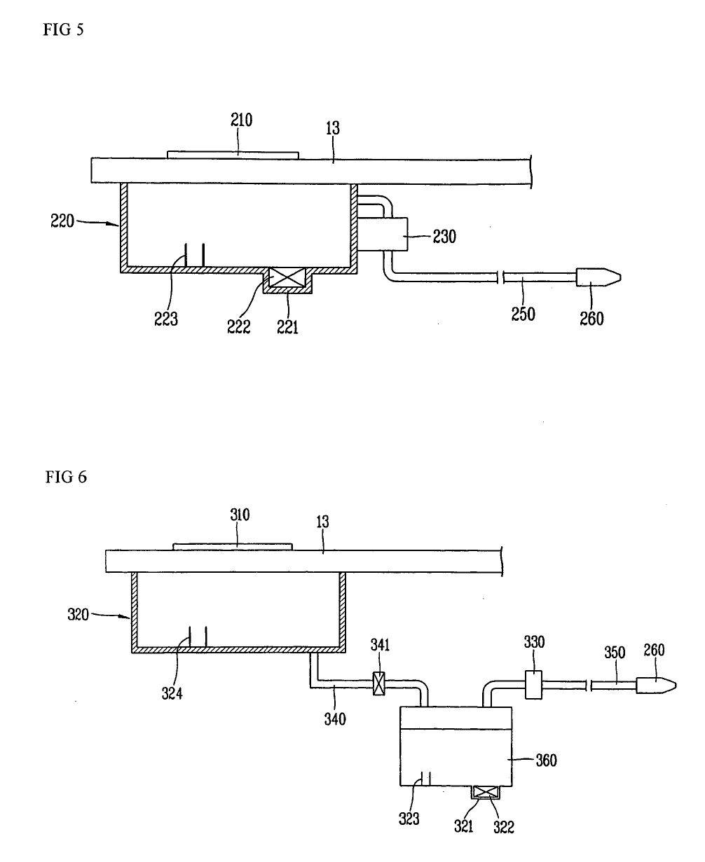

FIG. 6 illustrates a fragrance supply apparatus according to an exemplary embodiment of the present invention. Referring to FIG. 6, a cover unit 210 may be disposed at the top plate 13 so as to open and close a storage chamber 320 where liquid fragrance of a fragrance supplying apparatus may be stored. A first fluid level sensor 324 for sensing the level of the liquid fragrance stored in the storage chamber may be installed on the bottom of the storage chamber 320.

One end of a hose 340 may be connected to the bottom of the storage chamber 320, and another end thereof may be connected to an atomizer 360. The hose 340 can serve to transfer the liquid fragrance stored in the storage chamber 320 to the atomizer 360. A receiving groove 321 for receiving a vibrator 322 therein may be concavely formed at a bottom of the atomizer, and a second fluid level sensor 323 may be provided on a bottom of the atomizer so as to sense an amount of the liquid fragrance stored in the atomizer.

In addition, the hose 340 has a check valve 341 such that the amount of the liquid fragrance to be supplied to the atomizer 360 may be controlled and adjusted. That is, the check valve 341 is usually closed to prevent the liquid fragrance from flowing through the hose 340. If the second fluid level sensor 323 senses that the amount of the liquid fragrance stored in the atomizer 360 is less than a certain preset amount, the second fluid level sensor 323 transmits a signal to a microcontroller, (not shown) of the dryer. Upon receiving the signal, the microcontroller can open the check valve 341 to enable the supply of the liquid fragrance stored in the storage chamber to the atomizer.

A tube 350 may be connected to an upper side of the atomizer 360 such that the fragrance atomized from the atomizer is conducted to the drum of the dryer. A spray nozzle 260 for spraying the fragrance into the drum may be provided at an end of the tube 350. The tube 350 may have a blowing fan 330 for blowing the atomized fragrance.

The above exemplary embodiments have described a fragrance supplying apparatus for supplying fragrance to the drum by using the vibrator is installed at the top plate 13 of the dryer. However, the fragrance supplying apparatus may be installed at other locations, such as the front supporter 28 of the dryer and the like.

The fragrance spraying drying process in the condensed type dryer 10 according to the present disclosure will now be described. First, the user opens the door 24, puts laundry into the drum 15, and selects one of fragrance drying courses through the input unit at the control panel 14. Once the drying process is started, the heater 18 heats air introduced into the drum 15. When it is time to spray fragrance into the drum of the dryer, the vibrator disposed at either the storage chamber or the atomizer vibrates, and atomizes the liquid fragrance into a mist, to spray the liquid fragrance into the drum through the tube.

The user may select the time when fragrance needs to be sprayed. In this instance, the user may manually manipulate the control panel to spray the fragrance. Alternatively, the time when fragrance needs to be sprayed may be automatically controlled by the microcontroller according to a drying course selected by the user among various drying courses programmed in the dryer in advance.

After the dryer finishes a plurality of drying processes, if the fragrance stored in the fragrance supplying apparatus is all consumed and needs to be replenished, the first fluid level sensor 223 for measuring the amount of the liquid fragrance stored in the storage chamber senses such shortage of the fragrance, and generates a signal to notify the same to the user via the microcontroller. The user can then pour liquid fragrance into the storage chamber, to replenish the liquid fragrance.

The foregoing embodiments and advantages are merely exemplary and are not to be construed as limiting the scope of the invention. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A clothes dryer, comprising:
a main body;
a drum rotatably installed in the main body;
a storage chamber for storing liquid fragrance supplied into the drum; and
a vibrator disposed inside the storage chamber for atomizing the liquid fragrance.

2. The clothes dryer of claim 1, wherein the storage chamber is connected to a spray nozzle through a tube for guiding the atomized fragrance into the drum.

3. The clothes dryer of claim 2, wherein the tube has a fan for blowing the atomized fragrance.

4. The clothes dryer of claim 2, wherein the spray nozzle is disposed at a front supporter or a rear supporter of the clothes dryer to face an upper portion of the drum.

5. The clothes dryer of claim 1, wherein a first fluid level sensor is disposed inside the storage chamber to sense an amount of the liquid fragrance stored in the storage chamber.

6. The clothes dryer of claim 5, wherein a control panel for displaying an operational state of the dryer is positioned at an upper portion of a front surface of the main body, and the control panel has a display unit for displaying a state in which an amount of the liquid fragrance sensed by the first fluid level sensor is determined to be less than a preset amount.

7. The clothes dryer of claim 5, wherein if the amount of the liquid fragrance sensed by the first fluid level sensor is determined to be less than a certain preset amount, the vibrator stops operating.

8. A clothes dryer, comprising:
a main body;
a drum rotatably installed in the main body;
a storage chamber for storing liquid fragrance supplied into the drum wherein the storage chamber includes a first fluid level sensor; and
an atomizer connected to the storage chamber through a hose, for atomizing the liquid fragrance using a vibrator.

9. The clothes dryer of claim 8, wherein a second fluid level sensor is provided inside the atomizer to sense an amount of the liquid fragrance stored in the storage chamber.

10. The clothes dryer of claim 9, wherein the hose has a check valve such that if an amount of the liquid fragrance in the atomizer sensed by the second fluid level sensor is determined to be less than a preset amount, the check valve is opened.

11. The clothes dryer of claim 8, wherein the atomizer is communicated with a spray nozzle through a duct for guiding the atomized fragrance into the drum.

12. The clothes dryer of claim 11, wherein a fan for blowing the atomized fragrance is disposed inside the duct.
